(19) United States
(12) Patent Application Publication
(10) Pub. No.: US 2022/0357300 A1
(43) Pub. Date: Nov. 10, 2022

(54) METHOD FOR DETERMINING THE ELECTROPHORETIC MOBILITY OF EMULSION DROPLETS

(71) Applicants: TotalEnergies SE, Courbevoie (FR); CENTRE NATIONAL DE LA RECHERCHE SCIENTIFIQUE, Paris (FR); ECOLE SUPERIEURE DE PHYSIQUE ET DE CHIMIE INDUSTRIELLES DE LA VILLE DE PARIS, Paris (FR); SORBONNE UNIVERSITE, Paris (FR)

(72) Inventors: Michael Levant, Pau (FR); Enric Santanach Carreras, Louey (FR)

(73) Assignees: TotalEnergies SE, Courbevoie (FR); CENTRE NATIONAL DE LA RECHERCHE SCIENTIFIQUE, Paris (FR); ECOLE SUPERIEURE DE PHYSIQUE ET DE CHIMIE INDUSTRIELLES DE LA VILLE DE PARIS, Paris (FR); SORBONNE UNIVERSITE, Paris (FR)

(21) Appl. No.: 17/621,647

(22) PCT Filed: Jul. 11, 2019
(86) PCT No.: PCT/IB2019/000867

§ 371 Date: Dec. 21, 2021

(51) Int. Cl. G01N 27/447; G01N 15/00

(52) U.S. Cl. CPC G01N 27/447; G01N 15/00; G01N 2015/0003; G01N 2015/003; E21B 43/20

(57) ABSTRACT

The invention relates to a method for determining the electrophoretic velocity of droplets of a first fluid in a second fluid, the method comprising: providing a first capillary (3′) having an outlet positioned in a first channel (3); providing a stream of the first fluid in the first capillary and providing a stream of the second fluid in the first channel external to the first capillary, so as to generate droplets of the first fluid in the second fluid at the outlet of the first capillary; transporting the droplets to an observation area (200) in a second channel (11); applying an electric field to the observation area of the second channel; and measuring the velocity of the droplets in the observation area. The invention also relates to a device for determining the electrophoretic velocity of droplets of a first fluid in a second fluid.

### TECHNICAL FIELD

The present invention relates to a method for determining the electrophoretic velocity (and thus the electrophoretic mobility) of a plurality of emulsion droplets, notably in an oil-in-water emulsion.

### TECHNICAL BACKGROUND

Hydrocarbons (such as crude oil) are extracted from a subterranean formation (or reservoir) by means of one or more production wells drilled in the reservoir. Before production begins, the formation, which is a porous medium, is saturated with hydrocarbons.

The initial recovery of hydrocarbons is generally carried out by techniques of “primary recovery”, in which only the natural forces present in the reservoir are relied upon. In this primary recovery, only part of the hydrocarbons is ejected from the pores by the pressure of the formation. Typically, once the natural forces are exhausted and primary recovery is completed, there is still a large volume of hydrocarbons left in the reservoir.

This phenomenon has led to the development of enhanced oil recovery (EOR) techniques. Many of such EOR techniques rely on the injection of a fluid into the reservoir in order to produce an additional quantity of hydrocarbons.

The fluid used can in particular be an aqueous solution (“waterflooding process”), such as brine, which is injected via one or more injection wells.

Large amounts of water can also be recovered from the production wells. This is called “produced water”. The produced water can be e.g. discharged to the environment (after treatment) or reinjected into the subterranean formation via the injection wells.

A polymer can also be added to the water to increase its viscosity and increase its sweep efficiency in recovering hydrocarbons (“polymer flooding process”). In this case, the produced water contains part of the polymer, which can thus be recovered.

However, in a subterranean formation, droplets of hydrocarbons may be “trapped” in small cavities, therefore surfactants are often used for the mobilization of residual hydrocarbons, as they tend to generate a sufficiently low hydrocarbon/brine interfacial tension which makes it possible to overcome capillary forces and allow hydrocarbons to flow.

In order to enhance oil recovery and increase the microscopic efficiency of flooding processes, information concerning the influence of parameters such as the wettability on the flooding conditions is important. Moreover, information about the electrokinetic potential (or ζ-potential) of the oil-brine interface as well as the electrokinetic potential of the brine-rock interface can provide insight on the wettability conditions.

Nowadays, the determination of the electrokinetic potential of the oil-brine interface usually involves the combination of two distinct steps: a first emulsification step during which an oil-in-water emulsion is formed by using a surfactant and a second electrophoresis step in order to measure the electrophoretic velocity and then calculate the electrokinetic potential. However, in this technique, the stability of the emulsion is not assured, in other words depending on the time interval between the two steps (emulsification and electrophoresis), unstable emulsions might lead to droplet coalescence and eventually to phase separation via creaming, which renders the measurements impossible. Further disadvantages of this technique include the use of large quantities of liquid (oil and brine) and migration of the dispersed phase of an emulsion, either upwards or downwards depending on the size and the density of the dispersed droplets.

The article of Chu L.-Y et al. (Controllable monodisperse multiple emulsions), 2007 (doi: 10.1002/ange.200701358), relates to the formation of highly controlled multiple emulsions and microcapsules, by implementing microfluidic technology.

The article of Kim S.-H. et al. (One-step emulsification of multiple concentric shells with capillary microfluidic devices), 2011 (doi: 10.1002/anie.201102946) relates to a method for producing monodisperse multiple emulsion drops of high order by using a capillary microfluidic device and based on co-axial multiphase flows which are stabilized by confinement in the microcapillary and form emulsion drops.

Document WO 2009/029229 relates to ferrofluid emulsions and/or magnetically susceptible particles, which in some cases may be produced in a microfluidic system. Such emulsions may comprise for example, a polymer precursor which may be solidified, a stabilizing agent or a viscous agent.

The article of Chang M.-H. et al. (ζ-Potential analyses using micro-electrical field flow fractionation with fluorescent nanoparticles), 2007 (doi: 10.1016/j.snb.2006.12.019) relates to the determination of the ζ-potential for polystyrene nanoparticles using micro-electrical field flow fractionation which is a method for sorting particles by size.

The article of Delgado, A. V. et al. (Measurement and interpretation of electrokinetic phenomena), 2006 (doi: 10.1016/j.cis.2006.12.075) reviews recent progress in electrokinetics and relates to practical rules for performing electrokinetic measurements and interpreting the results in terms of well-defined quantities, such as the ζ-potential.

There is still a need for a method for measuring the electrophoretic mobility or velocity of droplets in an emulsion, in an efficient and simplified manner, without using large quantities of fluids, in order to facilitate the determination of parameters such as the electrokinetic potential. There is especially a need for measuring such electrophoretic mobility or velocity in emulsions which tend to be unstable in bulk.

### SUMMARY OF THE INVENTION

It is a first object of the invention to provide a method for determining the electrophoretic velocity of droplets of a first fluid in a second fluid, the method comprising:
providing a first capillary having an outlet positioned in a first channel;
providing a stream of the first fluid in the first capillary and providing a stream of the second fluid in the first channel external to the first capillary, so as to generate droplets of the first fluid in the second fluid at the outlet of the first capillary;
transporting the droplets to an observation area in a second channel;
applying an electric field to the observation area of the second channel; and
measuring the velocity of the droplets in the observation area.

The measurement of the velocity of the droplets is preferably based on a measurement of the position of individual droplets at different points in time, from which the velocity can be calculated.

According to some embodiments, the residence time of the droplets between the outlet of the first capillary and the observation area is from 1 ms to 1 h, preferably from 1 s to 10 min.

According to some embodiments, the composition of the first fluid and/or the composition of the second fluid are modified by the addition of additional compounds during the implementation of the method.

According to some embodiments, the first fluid is oil.

According to some embodiments, the oil derives from hydrocarbons recovered from a production well.

According to some embodiments, the second fluid is an aqueous solution.

According to some embodiments, the aqueous solution derives from produced water, sea water, aquifer water or fresh water.

According to some embodiments, the aqueous solution has a salinity from 10⁻⁶ to 3 M.

According to some embodiments, the first fluid stream has a flow rate from 0.0001 to 1 μL/min, and preferably from 0.001 to 0.01 μL/min.

According to some embodiments, the second fluid stream has a flow rate from 0.01 to 1000 μL/min, and preferably from 1 to 100 μL/min.

According to some embodiments, the droplets have an average diameter from 1 to 500 μm, and preferably from 10 to 100 μm.

According to some embodiments, the electric field has a magnitude from 0.1 to 1000 V/cm, and preferably from 5 to 50 V/cm.

According to some embodiments, the electric field is a DC electric field, or an AC electric field having a frequency from 10 to 100 Hz, and preferably from 0.1 to 1 Hz.

According to some embodiments, the electric field is parallel to the direction of the droplets, when the droplets are in the observation area.

According to some embodiments, the electric field is perpendicular to the direction of the droplets when the droplets are in the observation area.

According to some embodiments, the first fluid and/or the second fluid are devoid of surfactants.

According to some embodiments, the velocity of the droplets in the observation area is measured by recording images of the observation area and tracking droplets on successive images.

According to some embodiments, the velocity of the droplets in the observation area is also measured in the absence of an electric field, and a difference between the measured velocity of the droplets in the observation area in the presence and in the absence of the electric field is calculated.

According to some embodiments, the electrophoretic velocity is directly determined based on the difference between the measured velocity of the droplets in the observation area in the presence and in the absence of the electric field, in the substantial absence of electroosmotic flow in the observation area.

According to some embodiments, the electric field is applied to the observation area perpendicularly to a main direction of flow in the observation area.

According to some embodiments, an electroosmotic flow-suppressing coating is present on the internal surfaces of the observation area, the coating preferably being made from a poly-vinyl alcohol polymer or a poly-vinyl pyrrolidone polymer.

According to some embodiments, the electrophoretic velocity is calculated by subtracting an electroosmotic flow velocity from the difference between the measured velocity of the droplets in the observation area in the presence and in the absence of the electric field.

According to some embodiments, the electroosmotic flow velocity is determined by applying the electric field to the observation area and by injecting tracers in the second fluid and measuring the velocity of the tracers.

According to some embodiments, the electroosmotic flow velocity is determined by carrying out the steps of:
providing a stream of second fluid in the second channel, without providing droplets of the first fluid;
measuring a streaming potential voltage in the observation area; and deducing therefrom the electroosmotic flow velocity.

According to some embodiments, the electroosmotic flow velocity is determined by carrying out the steps of:
providing a stream of second fluid in the second channel, without providing droplets of the first fluid;
stopping the flow of the second fluid;

applying an electric field to the observation area of the second channel (11);
measuring a pressure drop across the observation area; and deducing therefrom the electroosmotic flow velocity.

According to some embodiments:—
the velocity of the droplets is measured in the observation area in pressure-imposed boundary conditions and in flow-imposed boundary conditions;
the electrophoretic velocity is calculated by adding the velocity in the presence of the electric field in pressure-imposed boundary conditions and the velocity in the presence of the electric field in flow-imposed boundary conditions, and dividing by two.

According to some embodiments, the method further comprises a step of determining the electrophoretic mobility of the droplets based on the electrophoretic velocity of the droplets.

According to some embodiments, the method further comprises a step of determining the electrokinetic potential of the droplets based on the electrophoretic velocity of the droplets.

It is another object of the invention to provide a device for determining the electrophoretic velocity of droplets of a first fluid in a second fluid, the device comprising:
a first channel;
a first capillary having an outlet, placed within the first channel;
a second channel in fluid communication with the first channel, wherein the second channel comprises an observation area; and
electrodes for applying an electric field in the observation area.

According to some embodiments, the first channel and the second channel are:
made by 3D-printing or machined in a single piece; or
made by 3D-printing or machined as an assembly of separate interconnected parts; or
respective capillaries assembled together.

According to some embodiments, the first channel has a square cross-sectional shape.

According to some embodiments, at the outlet of the first capillary, the inner diameter of the first channel is equal to or less than 5 times the outer diameter of the first capillary.

According to some embodiments, the first channel comprises a first portion and a second constricted portion.

According to some embodiments, the first portion has a square cross-sectional shape formed by four walls, each wall having a width from 0.1 to 5 mm, and preferably from 0.5 to 1.5 mm.

According to some embodiments, the first portion has a length in the longitudinal direction from 10 to 50 mm, and preferably from 20 to 40 mm.

According to some embodiments, the second portion has a square cross-sectional shape formed by four walls, each wall having a width from 0.05 to 1 mm, and preferably from 0.1 to 0.5 mm.

According to some embodiments, the first capillary has an outer diameter from 0.055 to 5.0 mm and/or the width of each wall of the second portion is equal to or less than five times the outer diameter of the first capillary at its outlet.

According to some embodiments, the second portion has a length in the longitudinal direction from 1 to 10 mm, and preferably from 2 to 8 mm.

According to some embodiments, the first capillary has an internal diameter from 0.005 to 4.5 mm, and preferably from 0.01 to 1.3 mm

According to some embodiments, the first capillary is tapered at its outlet.

According to some embodiments, the first capillary has an internal diameter at its outlet from 0.005 to 0.2 mm, and preferably from 0.01 to 0.1 mm.

According to some embodiments, the first capillary has a length in the longitudinal direction from 10 to 50 mm, and preferably from 20 to 40 mm.

According to some embodiments, the distance between the outlet of the first capillary and the observation area is from 100 μm to 10 m, and preferably from 1 mm to 10 cm.

According to some embodiments, the second channel is connected to the first channel via a second capillary, wherein the second capillary has a first part placed in the first channel and a second part placed in the second channel.

According to some embodiments, the outlet of the first capillary is placed in the second capillary or in the third channel.

According to some embodiments, the second capillary or the third channel has an internal diameter from 0.025 to 0.3 mm, and preferably from 0.05 to 0.1 mm.

According to some embodiments, the second capillary has an external diameter from 2.5 to 6 mm.

According to some embodiments, the second capillary or the third channel has a length from 10 to 50 mm, and preferably from 15 to 25 mm.

According to some embodiments, the device further comprises an inlet for a first fluid, and wherein the inlet for a first fluid is in communication with the first capillary.

According to some embodiments, the device further comprises an additional inlet for a second fluid, wherein the inlet for a second fluid is in communication with the first channel.

According to some embodiments, the device further comprises one or more pumps connected to the inlet for a first fluid and/or the inlet for a second fluid.

According to some embodiments, the second channel has a square cross-sectional shape.

According to some embodiments, the second channel has a square cross-sectional shape formed by four walls, each wall having a width from 0.1 to 5 mm, and preferably from 0.5 to 1.5 mm.

According to some embodiments, the second channel has a length in the longitudinal direction from 10 to 50 mm, and preferably from 20 to 40 mm.

According to some embodiments, the first channel and the second channel are capillaries.

According to some embodiments, the device comprises a first module and a second module, the two modules being connected to each other, the first module comprising the first channel, and the second module comprising the second channel.

According to some embodiments, the first module and the second module are connected to each other via a capillary.

According to some embodiments, the electrodes for applying an electric field are inserted into grooves.

According to some embodiments, the electrodes are located longitudinally spaced apart, one electrode being located upstream of the observation area and the other electrode being located downstream of the observation area.

According to some embodiments, the electrodes are located on opposite walls of the second channel, at the same longitudinal position along said second channel.

According to some embodiments, the electrodes generate an electric field which is substantially parallel to a direction of observation of droplets in the observation area; or which is substantially perpendicular to a direction of observation of droplets in the observation area.

According to some embodiments, the electrodes have the form of metal wires, or metal rods, or metal tubes, or metal-coated glass slides, or a coating made from a conductive material. Silver can be cited as an example of metal used in the electrodes.

According to some embodiments, the electrodes have the form of metal-coated glass slides in order to generate an electric field which is substantially parallel to a direction of observation of droplets in the observation area.

According to some embodiments, the device further comprises a camera and optionally a microscope proximate to the observation area.

According to some embodiments, a coating is present on the internal surfaces of the observation area, the coating preferably being made from a poly-vinyl alcohol polymer or a poly-vinyl pyrrolidone polymer.

The present invention makes it possible to address the need mentioned above. In particular, the invention provides a method for determining the electrophoretic velocity of droplets in an emulsion, in an efficient and simplified manner, without using large quantities of fluids (and possibly without using a large amount of surfactants or without using surfactants at all), in order to facilitate the determination of parameters such as the electrokinetic potential.

This method is particularly advantageous in the case of oil-in-water systems for which bulk emulsions would be unstable. By generating droplets individually and by measuring the velocity of individual droplets, issues related to unstable emulsions are circumvented. The droplets thus remain spatially separated which impedes coalescence during the time of the measurement.

This is achieved by using a device comprising a first channel wherein the formation of droplets occurs and a second channel wherein the measurement of the electrophoretic velocity of the droplets is carried out, the two channels being in fluid communication. Therefore, after their formation in the first channel, the droplets (each droplet being separated from the neighboring droplets, typically by a constant distance) directly enter the second channel, ensuring the stability and the homogeneity of emulsions that could otherwise become unstable over time. This device also makes it possible to work in a smaller scale, notably a microfluidic scale, thus smaller amounts of fluids can be used.

Therefore, the invention makes it possible to overcome the stability limitations by the physical separation of the droplets and to prevent droplet coalescence. It also makes it possible to perform a high throughput screening of the impact of different additives, or different conditions to the formation of droplets, e.g. by continuously adding fluids or other substances in order to modify the oil-in-water system and monitoring the impact of such modification on the electrophoretic velocity and/or electrokinetic potential.

One important aspect of the invention is the ability to control the residence time of the droplets between their generation and their observation. This residence time is advantageously adjusted according to the time required for equilibration of the droplet interface.

### BRIEF DESCRIPTION OF THE DRAWINGS

FIG. 1 schematically illustrates a device according to the present invention.

FIG. 2 schematically illustrates the formation of droplets inside the first channel according to one embodiment of the present invention.

FIGS. 3, 4B, 5B, 6B illustrate different trajectories of the droplets inside the second channel, due to the different electrode configurations.

FIGS. 4A, 5A and 6A illustrate a perspective view of the second channel of the device with different electrode configurations.

FIGS. 7 and 8 illustrate a device according to one embodiment of the present invention.

FIG. 9 shows a perspective view of the first module of the device according to one embodiment of the present invention.

FIG. 10 shows a profile view of the first module of the device according to one embodiment of the present invention.

FIG. 11 shows a perspective view of the second module of the device according to one embodiment of the present invention.

FIG. 12 shows a profile view of the second module of the device according to one embodiment of the present invention.

### DESCRIPTION OF EMBODIMENTS

The invention will now be described in more detail without limitation in the following description.

The present invention is most preferably implemented in the context of oil and gas applications. By “oil and gas applications” is meant any method of extracting hydrocarbons from a subterranean formation, or of transporting, processing or treating a hydrocarbon-containing stream or a by-product stream resulting from hydrocarbon extraction.

### General Presentation of the Device and Method

The invention relates to a method for determining the electrophoretic velocity of a plurality of droplets of a first fluid in an emulsion formed by the first fluid, in a second fluid; as well as to a device for carrying out this method.

By “droplet” is meant an isolated portion of the first fluid that is surrounded by a second fluid, the first fluid being immiscible with the second fluid.

The first fluid may be an aqueous solution or oil. Preferably the first fluid is oil.

The second fluid may be an aqueous solution or oil. Preferably the second fluid is an aqueous solution.

Therefore, the emulsion may be an oil-in-water emulsion (wherein the droplets are oil droplets) or a water-in-oil emulsion (wherein the droplets are water droplets), and is preferably an oil-in-water emulsion.

The oil may derive from hydrocarbons recovered from a production site.

The aqueous solution may derive from produced water, sea water, fresh water or aquifer water.

The salinity of the aqueous solution may be from 10⁻⁶ to 3 M. Salinity is defined herein as the molar concentration of NaCl equivalent to the total concentration of dissolved inorganic salts in water, including e.g. NaCl, CaCl₂), MgCl₂ and any other inorganic salts.

Making reference to FIG. 1, the device of the invention is illustrated in a schematic manner. It comprises at least one droplet generation area 100 and at least one observation area 200. The two areas are fluidically connected via a connection 300. The connection 300 may comprise or consist in flexible tubing, a capillary, a microfabricated or 3D-printed channel, etc.

The droplets are generated in the droplet generation area 100 (in a first channel, as described in more detail below) and then transported to the observation area 200 where their velocity is measured (in a second channel, as described in more detail below). Said measurement is performed by observing and tracking the droplets along an observation axis (or direction of observation). The observation axis is generally perpendicular to the longitudinal direction of the second channel. The measurement of velocity is described in more detail below.

The term “longitudinal” refers to the main or average direction of flow.

By adjusting the length of the connection 300 and the flow rates of the fluids, it is possible to control the residence time of the droplets in the device between the droplet generation area 100 and the observation area 200.

The residence time of the droplets between the droplet generation area and the observation area 200 may range from 1 ms to 10 ms; or from 10 ms to 100 ms; or from 100 ms to 1 s; or from 1 s to 10 s; or from 10 s to 1 min; or from 1 min to 10 min; or from 10 min to 1 h.

The length of the connection 300 may range from 100 μm to 1 mm; or from 1 mm to 10 mm; or from 10 mm to 100 mm; or from 100 mm to 1 m; or from 1 m to 10 m.

The device of the invention may be modular. Thus, the droplet generation area 100 may belong to a first module and the observation area 200 may belong to a second module, as described in more detail below.

The two modules may be directly connected (or coupled) to each other (not shown). This means that the two modules are in fluid communication with each other and that the droplets formed in the first module enter directly (and/or continuously) the second module without being in contact with the exterior environment and without any waiting time between the exit of the droplet from the first module and their entrance in the second module.

Alternatively, the two modules are not directly connected to each other but may be connected via an intermediate tubing or capillary or the like. In this case, the droplets generated in the first module exit the first module, go through the intermediate tubing and then enter the second module. For example, by altering the length of the tubing, the residence time of the droplets between the droplet generation area and the observation area can be controlled. This is advantageous since equilibration of the droplet interface may be relatively slow.

Alternatively, the device according to the invention comprises a single module wherein the droplets may be formed and wherein their electrophoretic velocity can be measured. In other terms, the single module may comprise both the droplet generation area 100, the observation area 200 and the connection 300. By “single module” is meant a module formed in a single piece. In other words, the first module and the second module may be replaced by a single module integrally formed as a single piece. Again, the droplets formed in the device remain protected from the exterior environment and the measurement of their velocity is carried out directly after the droplet formation. In such variations, the second channel may simply be the continuation of the first channel; the two channels may be integrally formed.

According to some embodiments, the device according to the invention is a microfluidic device. The term “microfluidic” refers to articles or elements having some dimensions, or widths, or diameters of less than 1 mm, preferably less than 500 μm. Typically, all dimensions in said microfluidic device are larger than 1 μm, and preferably larger than 10 μm.

The device of the invention may be made by connecting together various capillaries. It may also be partly or fully microfabricated; for instance, it may be partly or fully manufactured by a 3D printing process.

### Droplet Generation

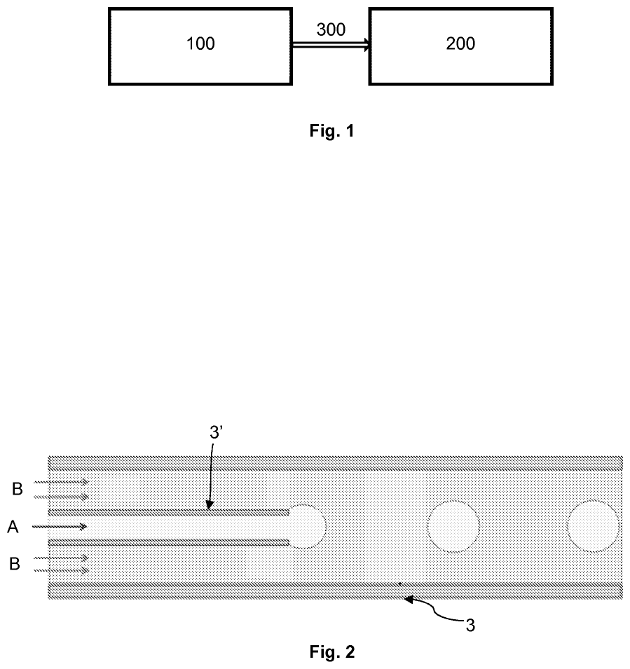

Making reference to FIG. 2, the droplet generation area comprises a first capillary 3′ having an outlet, arranged within a first channel 3.

A stream of a first fluid is provided in the first capillary 3′ and a stream of a second fluid is provided in the first channel 3, in order to generate a plurality of droplets of the first fluid in the second fluid.

As the first fluid flows through the first capillary 3′ (arrow A), and as the second fluid flows through the first channel 3 (arrows B), due to coaxial flow of the two fluids, droplets of the first fluid in the second fluid are formed. The droplets are then transported to the observation area.

The first capillary 3′ preferably has a circular cross-section and has an inlet and an outlet. Alternatively, the first capillary 3′ may have a cross-section that is not circular for example polygonal, or rectangular cross-section notably square cross-section.

The first capillary 3′ may be tapered at its outlet, in other words, the inner diameter and the outer diameter of the first capillary may decrease gradually over the length of the capillary. Therefore, the first capillary 3′ may have a first non-tapered end a second tapered end.

The inner diameter of the first capillary 3′ may be from 0.005 to 4.5 mm, and preferably from 0.01 to 1.3 mm. More particularly, the inner diameter of the first capillary 3′ may be from 0.2 to 4.5 mm, and preferably from 0.4 to 1.3 mm at the non-tapered end (inlet) of the capillary, and from 0.005 to 0.2 mm, and preferably from 0.01 to 0.1 mm at the tapered end (outlet) of the capillary.

The first capillary 3′ may have an outer diameter from 0.055 to 5.0 mm.

Besides, at the outlet of the first capillary 3′ in the first channel 3, the inner diameter of the first channel 3 is preferably equal to or less than 5 times the outer diameter of the first capillary 3′.

For a non-circular capillary or channel, the term “diameter” refers to the maximum dimension of the cross-section of capillary or channel.

In particular, the first channel 3 may have a rectangular cross-sectional shape, and preferably a square cross-sectional shape. In other words, the first channel 3 may be formed (or surrounded) by four walls (upper wall, lower wall, two lateral walls), all four walls preferably having the same dimensions, adjacent walls being perpendicular to each other.

The method according to the invention offers an advantage as it can be applied to oil-in-water systems which would tend to form unstable emulsions in bulk. In particular, the method of the invention may be applied without the use of surfactants. However, surfactants may also be used, especially if the influence of a surfactant on the electrophoretic velocity is to be studied.

The flow rate of the first fluid in the first capillary 3′ makes it possible to control the spacing between successively formed droplets. By “spacing” is meant the distance between the centers of two successively formed droplets.

Therefore, the first fluid stream may have a flow rate from 0.0001 to 1 μL/min, and preferably from 0.001 to 0.01 μL/min For example, this flow rate may be from 0.0001 to 0.0005 μL/min, or from 0.0005 to 0.001 μL/min, or from 0.001 to 0.005 μL/min, or from 0.005 to 0.01 μL/min, or from 0.01 to 0.05 μL/min, or from 0.05 to 0.1 μL/min, or from 0.1 to 0.5 μL/min, or from 0.5 to 1 μL/min.

The spacing between successively formed droplets may be equal to 3 to 100 times the diameter of a droplet, and preferably from 5 to 20 times the diameter of a droplet.

The flow rate of the second fluid in the first channel 3 makes it possible to control the size and more particularly the average diameter of the droplets.

Therefore, the second fluid stream may have a flow rate from 0.01 to 1000 μL/min, and preferably from 1 to 100 μL/min. For example, this flow rate may be from 0.01 to 0.05 μL/min; or from 0.05 to 0.1 μL/min; or from 0.1 to 0.5 μL/min; or from 0.5 to 1 μL/min; or from 1 to 5 μL/min; or from 5 to 10 μL/min; or from 10 to 50 μL/min; or from 50 to 100 μL/min; or from 100 to 150 μL/min; or from 150 to 200 μL/min; or from 200 to 250 μL/min; or from 250 to 300 μL/min; or from 300 to 350 μL/min; or from 350 to 400 μL/min; or from 400 to 450 μL/min; or from 450 to 500 μL/min; or from 500 to 550 μL/min; or from 550 to 600 μL/min; or from 600 to 650 μL/min; or from 650 to 700 μL/min; or from 700 to 750 μL/min; or from 750 to 800 μL/min; or from 800 to 850 μL/min; or from 850 to 900 μL/min; or from 900 to 950 μL/min; or from 950 to 1000 μL/min.

The droplets may have an average diameter from 1 to 500 μm, and preferably from 10 to 100 μm. Therefore, the average diameter of the droplets may be from 1 to 5 μm; or from 5 to 10 μm; or from 10 to 25 μm; or from 25 to 50 μm; or from 50 to 75 μm; or from 75 to 100 μm; or from 100 to 150 μm; or from 150 to 200 μm; or from 200 to 250 μm; or from 250 to 300 μm; or from 300 to 350 μm; or from 350 to 400 μm; or from 400 to 450 μm; or from 450 to 500 μm.

Furthermore, the first capillary 3′ may have a length in the longitudinal direction from 10 to 50 mm, and preferably from 20 to 40 mm. For example, the first capillary 3′ may have a length in the longitudinal direction from 10 to 15 mm; or from 15 to 20 mm; or from 20 to 25 mm; or from 25 to 30 mm; or from 30 to 35 mm; or from 35 to 40 mm; or from 40 to 45 mm; or from 45 to 50 mm.

The method may also comprise a step of injecting one or more additional compounds such as surfactants, pH adjustment agents, polymers, salts . . . . The one or more additional compounds may be injected to the stream of first fluid and/or the stream of second fluid.

The addition of one or more additional compounds makes it possible to modify the composition of the first fluid and/or second fluid during the implementation of the method, so as to monitor the impact of one or more factors (such as the salinity of an aqueous fluid, or the nature or concentration of surfactant) on the electrophoretic velocity of the droplets.

The residence time of the droplets between the droplet generation area (outlet of the first capillary 3′) and the observation area may be controlled by adjusting the length of the connection between these areas and by adjusting the flow rates of the fluids.

### Generation of the Electric Field

An electric field is generated in the observation area of the device of the invention. The observation area is provided in the second channel.

The second channel may have a rectangular cross-sectional shape, and preferably a square cross-sectional shape. In other words, the second channel may be formed (or surrounded) by four walls (upper wall, lower wall, two lateral walls), all four walls preferably having the same dimensions, adjacent walls being perpendicular to each other, and preferably a square shape.

According to some embodiments, each wall of the second channel may have a width from 0.1 to 5 mm, and preferably from 0.5 to 1.5 mm. For example, each wall may have a width from 0.1 to 0.5 mm; or from 0.5 to 1 mm; or from 1 to 1.5 mm; or from 1.5 to 2 mm; or from 2 to 2.5 mm; or from 2.5 to 3 mm; or from 3 to 3.5 mm; or from 3.5 to 4 mm; or from 4 to 4.5 mm; or from 4.5 to 5 mm.

The second channel may have a length in the longitudinal direction from 10 to 50 mm, and preferably from 20 to 40 mm. For example, the second channel may have a length in the longitudinal direction from 10 to 15 mm; or from 15 to 20 mm; or from 20 to 25 mm; or from 25 to 30 mm; or from 30 to 35 mm; or from 35 to 40 mm; or from 40 to 45 mm; or from 45 to 50 mm.

To this end, the device according to the invention preferably further comprises electrodes for applying an electric field over the second channel and more particularly in the observation area. These electrodes may be formed e.g. of metal wires, metal rods, metal tubes, metal-coated glass slides, or a coating made from a conductive material.

Preferably, two electrodes are used. Preferably, these electrodes are parallel to each other.

More generally, and in other variations of the device, the electrodes may be arranged in the second channel or external to the second channel. They can also be implemented with fluid ports at the inlet and outlet of the second channel.

In case the device comprises a first module and a second module as described above, the electrodes are comprised in the second module.

For example, a first electrode may be located proximally to the inlet of the second module and a second electrode may be located proximally to the outlet of the second module.

The electrodes may be located on (or inserted into) an upper surface and/or a lower surface and/or one or more side surfaces of the device, or of the second module of the device.

According to some embodiments, the electrodes may be located on (or inserted into) only the upper surface of the device (or of the second module of the device), or only the lower surface of device (or of the second module of the device).

According to some embodiments, the electrodes may be respectively located on (or inserted into) the upper surface and lower surface of the device (or of the second module of the device).

According to other embodiments, the electrodes may be respectively located on (or inserted into) opposite side surfaces of the device (or of the second module of the device).

For example, the electrodes (e.g. in the form of metal wires) may be inserted into grooves formed on one or more than one of the surfaces of the device (or of the second module of the device). The grooves may extend to and communicate with the internal space of the second channel. The electrodes may thus be placed within the second channel. These grooves must be sealed after insertion of the electrodes and prior to the circulation of fluid. Alternatively, the grooves (and the electrodes that they contain) may be at a distance from the internal space.

According to other embodiments, the electrodes may have the form of a coating made from a conductive material, such as epoxy for example. This embodiment is especially advantageous when the second channel is a four-wall (e.g. square) cross-sectional capillary having four walls. The conductive coating may then be present on the outer surface of two opposite walls of the second channel. This is advantageous as the fluid inside the second channel is not in contact with the electrodes, which makes it possible to use fluids having different conductivities.

Alternatively, the electrodes may have the form of metal-coated glass slides, such as indium-tin-oxide coated glass. When the second channel is a four-wall (e.g. square) cross-sectional capillary, these slides may replace at least two of the four walls of the second channel. For example, a first slide may replace the upper wall of the second channel and a second slide may replace the lower wall of the second channel. Alternatively, a first slide may replace a first lateral wall of the second channel and a second slide may replace a second lateral wall of the second channel.

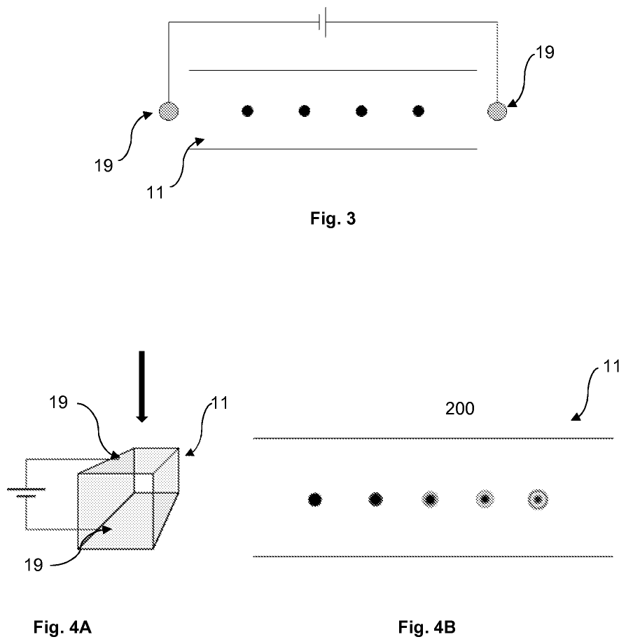

Making reference to FIG. 3, the electric field may be applied parallel to the (main) direction of flow, i.e. to the longitudinal orientation of the second channel 11 in the observation area. To this end, use is made of two electrodes 19 which are spaced apart longitudinally, one electrode 19 being located upstream of the observation area and the other electrode 19 being located downstream of the observation area. For instance, one electrode 19 may be placed in the second channel 11 upstream the observation area, and another electrode 19 may be placed in the second channel 11 downstream the observation area. In this case, the trajectory of the droplets remains substantially longitudinal as they move in the second channel 11 along the observation area.

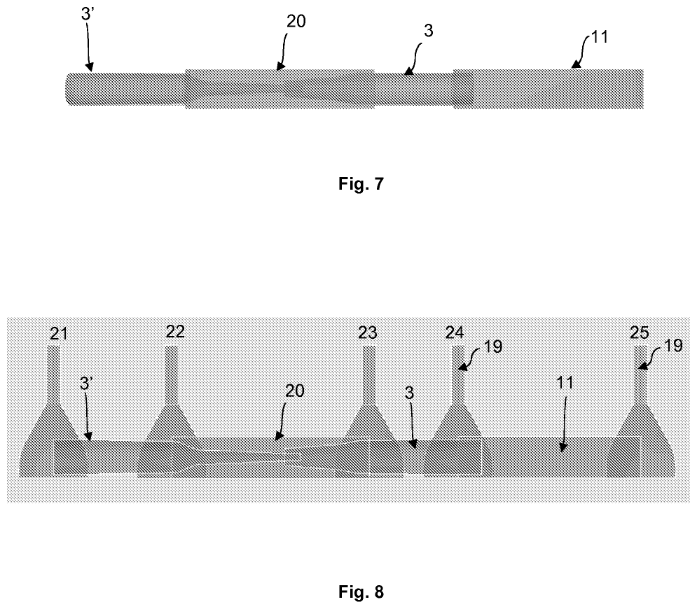

Such a configuration is the one used in the exemplary devices described in more detail below with reference to FIGS. 7 to 12.

Alternatively, the electric field may be applied perpendicular to the (main) direction of flow, i.e. to the longitudinal orientation of the second channel 11 in the observation area.

More particularly, as shown in FIGS. 4A and 4B, the main direction of the electric field may be aligned with the observation axis (as indicated by the arrow in FIG. 4B). Thus, the electrodes 19 may be arranged on or along the upper wall and the lower wall of the second channel 11. For example, these electrodes may be formed as a conductive coating on the upper wall and lower wall (for example made of glass) of the second channel 11. As a result, the trajectory of the droplets deviates in the observation area, as they tend to move closer to one of the electrodes 19, i.e. towards the upper wall or the lower wall of the second channel 11. The displacement of the droplets along an observation axis which in this case is perpendicular to the upper and the lower walls of the second channel 11, may result in a diffraction pattern where a ring is observed around droplets as they move in the observation area (this effect is shown in FIG. 4B). The size and shape of the diffraction ring varies depending on the displacement of the droplets.

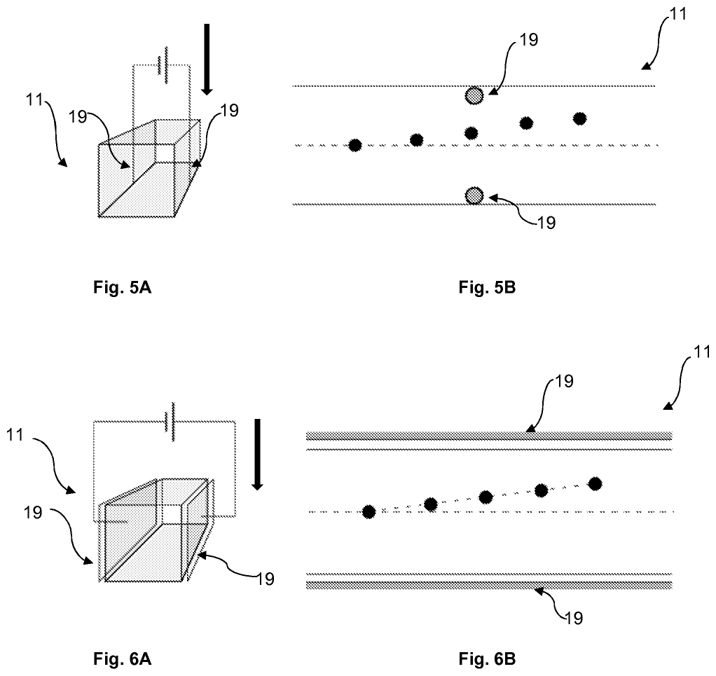

Alternatively, as shown in FIGS. 5A and 5B, the main direction of the electric field may be perpendicular to the (main) direction of flow, i.e. to the longitudinal orientation of the second channel 11 in the observation area, and also perpendicular to the observation axis (indicated by the arrow in FIG. 5B). Thus, the electrodes 19 may be arranged on or along the lateral walls of the second channel 11. As illustrated in FIGS. 5A and 5B, the electrodes 19 may be introduced into grooves located in the two lateral walls of the second channel 11. The trajectory of the droplets deviates in the observation area, as they tend to move closer to one of the electrodes 19, i.e. towards one of the two lateral walls of the second channel 11. The trajectory of the droplets therefore changes as indicated in FIG. 5B, and as observed from an observation axis which is parallel to the two lateral walls of the channel 11.

A variation is shown in FIGS. 6A and 6B, where the electrodes 19 are formed as plates which cover the two lateral walls of the second channel 11. The trajectory of the droplets deviates in the observation area, as described above in relation with FIGS. 5A and 5B. This embodiment offers the advantage of suppressing the impact of the electroosmotic flow, while offering a uniform electric the field in the observation area.

According to some embodiments, the device may be part of an assembly which further comprises an electric field generator. The electric field generator can be connected to the electrodes in order to provide them with electric power.

An electric field is applied in the observation area when the droplets travel through this observation area.

The electric field may have a magnitude from 0.1 to 1000 V/cm, and preferably from 5 to 50 V/cm. For example, the electric field may have a magnitude from 0.1 to 1 V/cm; or from 1 to 5 V/cm; or from 5 to 50 V/cm; or from 50 to 100 V/cm; or from 100 to 150 V/cm; or from 150 to 200 V/cm; or from 200 to 250 V/cm; or from 250 to 300 V/cm; or from 300 to 350 V/cm; or from 350 to 400 V/cm; or from 400 to 450 V/cm; or from 450 to 500 V/cm; or from 500 to 550 V/cm; or from 550 to 600 V/cm; or from 600 to 650 V/cm; or from 650 to 700 V/cm; or from 700 to 750 V/cm; or from 750 to 800 V/cm; or from 800 to 850 V/cm; or from 850 to 900 V/cm; or from 900 to 950 V/cm; or from 950 to 1000 V/cm.

The electric field is preferably a direct current (DC) electric field, although in some embodiments an AC electric field can be used, as illustrated below.

### Velocity Measurement

The device according to the present invention, may comprise a system for recording and tracking droplet trajectories in the observation area. Such system may comprise, for example, a camera and optionally a microscope. Such system is located proximate to the observation area (for example above the upper surface and/or below the lower surface). The orientation of the camera defines the observation axis.

The velocity of droplets may be measured by tracking single droplets on successive recorded images of the observation area. When the electric field is applied, acceleration or deceleration of the droplets may occur, or a deviation of the trajectory of the droplets may occur, depending on the direction of the electric field. The droplets have a certain velocity distribution. By “measured velocity” is usually meant the average measured velocity (in given conditions) on a sample of droplets.

In some embodiments, the droplets have a substantially longitudinal movement in the observation area. In other embodiments, the droplets have a longitudinal velocity component and a transverse (i.e. perpendicular to longitudinal) velocity component.

The velocity of the droplets is the sum of several velocities:—
a velocity resulting from the overall flow of fluid (non-electric field related, caused for example by a pump);
the electrophoretic velocity vₑ of the droplets;
the electroosmotic flow velocity vₑₒ.

Electrophoresis is the motion of dispersed particles relative to a fluid under the influence of an electric field.

The electrophoretic velocity, vₑ (m/s), is the velocity of the dispersed particles during electrophoresis.

Electroosmosis is the motion of a liquid through a capillary tube, microchannel or any other fluid conduit, in response to an applied electric field. It is the result of the force exerted by the field on the counter-charge in the liquid inside the charged capillaries, pores, etc. The moving ions drag the liquid in which they are embedded along, parallel to the surface of the tube, channel or conduit. The electroosmotic flow velocity, vₑₒ (m/s), is the uniform velocity of the liquid far from the charged interface.

By measuring the velocity of the droplets in the absence and in the presence of the electric field and determining the difference between the two, the non-electric field related velocity can be subtracted, and the sum of vₑ+vₑₒ is obtained.

The electrophoretic velocity of the droplets vₑ can be calculated by subtracting the electroosmotic flow velocity vₑₒ from the measured velocity of the droplets. Alternatively, in other embodiments, the electroosmotic flow can be substantially suppressed (i.e. vₑₒ is approximately zero).

In order to suppress the electroosmotic flow, the electrical field may be applied perpendicularly to the main direction of flow (longitudinal orientation of the second channel 11). Indeed, in this configuration (as described above in relation with FIGS. 4A, 4B, 5A, 5B, 6A and 6B), the influence of the electroosmotic flow may be suppressed.

In the embodiment of FIGS. 4A and 4B, the measurement of the displacement and thus velocity of the droplets in a direction parallel to the electric field (and thus perpendicular to the main direction of flow), by analyzing the diffraction rings, directly provides the electrophoretic velocity vₑ.

In the embodiment of FIGS. 5A and 5B, the electric field in the observation area is not uniform. This means that integration of the values measured is required in order to determine the velocity of the droplets. Again, the measurement of the displacement and thus velocity of the droplets in a direction parallel to the electric field (and thus perpendicular to the main direction of flow) directly provides the electrophoretic velocity vₑ.

In the embodiment of FIGS. 6A and 6B, the electric field in the observation area is substantially uniform. Again, the measurement of the displacement and thus velocity of the droplets in a direction parallel to the electric field (and thus perpendicular to the main direction of flow) directly provides the electrophoretic velocity vₑ. However, this embodiment requires a calibration operation, since the electrodes 19 are positioned external to the second channel 11.

Alternatively, in order to suppress the electroosmotic flow, while still applying an electric field parallel to the second channel 11 (and thus parallel to the main direction of flow), a coating from a poly-vinyl alcohol polymer or a poly-vinyl-pyrrolidone polymer for example may be applied on the internal surfaces of the observation area. This makes it possible to substantially suppress the electroosmotic flow.

In this case, even if the electric field is parallel to the second channel 11 (and thus parallel to the main direction of flow), the electrophoretic velocity vₑ can be directly determined by measuring the velocity of the droplets in the absence and in the presence of the electric field and determining the difference between the two.

In other embodiments, the electrical field may be applied parallel to the main direction of flow, without suppressing the electroosmotic flow. In such a case, the electroosmotic flow velocity vₑₒ has to be subtracted from the measured velocity.

According to some embodiments, in order to determine the electroosmotic flow velocity, neutral tracers may be provided in the second fluid (typically in the absence of droplets of first fluid), and the velocity of these tracers may be measured in the presence of the electric field, so as to determine the electroosmotic flow velocity by subtracting the non-electric field related velocity from the measured velocity of the tracers. The velocity may for example be measured by particle tracking velocimetry (PTV) or by particle image velocimetry (PIV) or by bleaching velocimetry.

According to other embodiments, in order to determine the electroosmotic flow velocity, the following steps may be carried out:
providing a stream of second fluid in the second channel, without providing droplets of the first fluid;
measuring a streaming potential voltage in the observation area (for example using the electrodes described above); and
deducing therefrom the electroosmotic flow velocity.

In this case, the electrophoretic velocity of the droplets vₑ can be calculated by measuring the displacement and thus velocity of the droplets in a direction parallel to the electric field (and thus parallel to the main direction of flow), and subtracting the electroosmotic flow velocity vₑₒ from the measured velocity of the droplets.

A third method according to which the electroosmotic flow velocity can be evaluated and subtracted is a method wherein the electroosmotic velocity is measured in two types of boundary conditions: a first type wherein the measurement of the electroosmotic velocity is carried out in pressure imposed boundary conditions and a second type wherein the measurement of the electroosmotic velocity is carried out in flow imposed boundary conditions. By switching between the two boundary conditions and by measuring the respective velocities of the droplets, the electrophoretic velocity can be found.

Pressure imposed boundary conditions are such that mass can flow through a cross-section of the channel and both ends of the channel have the same pressure. In this configuration there is no pressure-driven backflow, only electroosmotic flow with constant electroosmotic velocity vₑₒ. For example, a constant pressure can be achieved by pressure controllers.

Flow imposed boundary conditions are such that mass cannot flow through the cross-section of the capillary and therefore pressure is different between both ends of the channel. This results in a back-pressure-driven-flow that distorts the uniform profile of the electroosmotic flow, in order to make sure that the net total flux through any cross-section of the capillary is zero. In this case, the droplets move across a centerline of the capillary where the velocity profile is at its maximum and equal to −vₑₒ. For example, the flow can be imposed by a pump, such as a syringe pump.

By switching between the two boundary conditions and by measuring the velocity of the droplets which in the pressure imposed boundary conditions would be vₑ+vₑₒ (along the centerline of the channel) and in the flow imposed boundary conditions would be vₑ−vₑₒ (along the centerline of the channel), the electrophoretic velocity vₑ can be measured. Said switching may be performed by opening and closing valves at respective fluid ports connected to the second channel.

Yet another manner to determine the electroosmotic flow velocity vₑₒ and subtract it from the measured velocity of the droplets is to measure a pressure difference resulting from the electroosmotic flow. In order to perform this measurement, a stream of second fluid without droplets is provided. This flow is stopped, the electric field is applied, thus generating electroosmotic flow inside the channel (in flow-imposed boundary conditions), which in turn generates a pressure difference across the channel, which can be measured.

According to preferred embodiments, the method according to the invention is implemented in a continuous manner. Therefore, the provision of a first fluid, the provision of a second fluid, the transportation of droplets, the application of an electric field and the measurement of the velocity of the droplets is implemented continuously for a certain period of time in order to obtain from 10 to 10 000 droplets, and preferably from 100 to 1 000 droplets.

By using the method according to the invention, apart from the electrophoretic velocity, other parameters may be determined.

According to some embodiments, the electrophoretic mobility (uₑ) may be determined.

The electrophoretic mobility, uₑ (m²/V.$), is the magnitude of the electrophoretic velocity divided by the magnitude of the electric field strength. The mobility is counted positive if the particles move toward lower potential (negative electrode) and negative in the opposite case.

According to other embodiments, the electrokinetic potential (ζ) may be determined. For example, the electrokinetic potential can be determined by using a theoretical model such as the Smoluchowski model.

According to some embodiments, during use, the device according to the invention may be placed vertically (the first channel and the second channel being oriented in the vertical direction), so that the movement of the droplets in the observation area may have the same direction as gravity. This may be preferable, in order to account for any influence of gravity to the trajectory of the droplets.

### Capillary-Based Device

According to some embodiments, and making reference to FIGS. 7 and 8, the device of the invention is a modular device which comprises an assembly of capillaries. More particularly, the device may comprise a first channel 3 which is itself a capillary. More specifically, the first capillary 3′ has a tapered outlet which is inserted into a tapered inlet of the first channel 3. A connection tube 20 is provided around a downstream portion of the first capillary (including the outlet of the first capillary 3′) and an upstream portion of the first channel 3 (including the inlet of the first channel 3).

The first fluid flows through the first capillary 3′. The second fluid is fed via the connection tube 20 and flows into the first channel 3. The connection between the connection tube 20 and the first channel 3 is preferably sealed.

A second channel 11, which may also be formed as a capillary, is connected to the outlet of the first channel 3. For example, the outlet of the first channel 3 may be inserted into the inlet of the second channel. The connection between the first channel 3 and the second channel 11 is preferably sealed.

All capillaries in this device may preferably be made from borosilicate glass or quartz.

Besides, each capillary end (inlet or outlet) may be provided with a fluid port for example in the form of a Luer connection.

More specifically, the inlet of the first capillary 3′ may be provided with a first fluid port 21. This first fluid port 21 may be used in particular to feed the first fluid to the first capillary 3′.

The inlet of the connection tube 20 may be provided with a second fluid port 22. This second fluid port 22 may be used in particular to feed the second fluid to the first channel 3 via the connection tube 20.

The outlet of the connection tube 20 may be provided with a third fluid port 23. The inlet of the second channel 11 may be provided with a fourth fluid port 24. The outlet of the second channel 11 may be provided with a fifth fluid port 25. The stream of first fluid and the stream of second fluid may be provided by two distinct pumps such as syringe pumps, each syringe pump being respectively connected to the inlet of the first capillary 3′ and to the inlet of the connecting tube 20, respectively.

Droplets generated in the first channel 3 are then transported by the flow of second fluid into and along the second channel 11, up to the observation area.

The electrodes 19 for applying the electric field in the observation area may be positioned in the fourth fluid port 24 and the fifth fluid port 25. Alternatively, the fourth fluid port 24 and the fifth fluid port 25 may be used as electrodes themselves, if they comprise a metallic portion.

### 3D-Printed Device

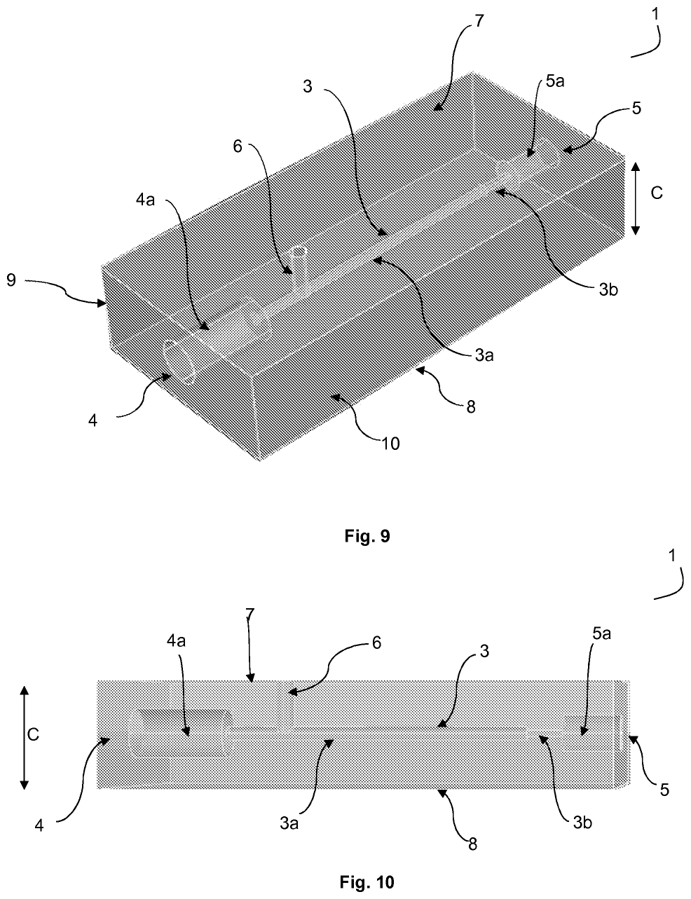

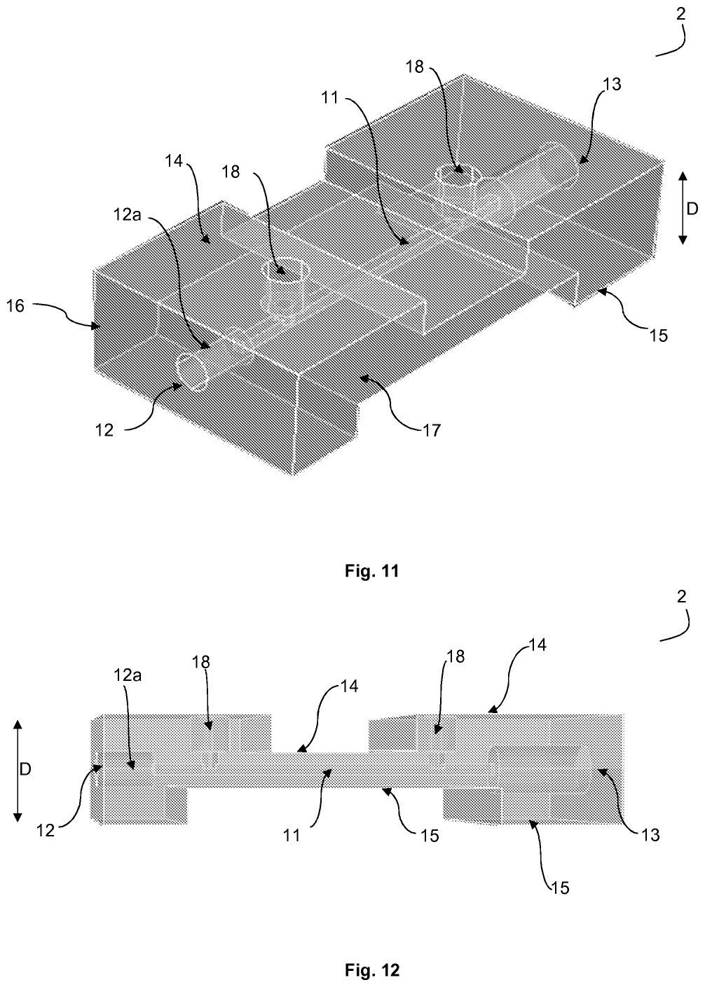

Another variation of the device of the invention is shown on FIGS. 9 to 12. This device may comprise a first module 1 (FIGS. 9 and 10) for the formation of droplets, and a second module 2 (FIGS. 11 and 12) for the measurement of the electrophoretic velocity of the droplets, the two modules 1, 2 being connected (or coupled) to each other (not shown). The first module 1 may preferably be 3D-printed. The second module 2 may preferably be 3D-printed. Each of the first module 1 and second module 2 may be for instance manufactured from a polymer material such as polycarbonate.

With reference to FIGS. 9 and 10, the first module 1 comprises a first channel 3 extending longitudinally from an inlet 4 to an outlet 5.

According to some embodiments (illustrated in FIGS. 9 and 10), the first channel 3 is microfabricated in the first module 1.

Furthermore, the first channel 3 may comprise a first portion 3a and a second portion 3b, the first portion 3a being in fluid communication with the second portion 3b and the second portion 3b being constricted. This means that the walls of the second portion 3b have smaller dimensions than the walls of the first portion 3a (as shown in FIG. 10). The first portion 3a is located proximately to the inlet 4 of the first module 1, while the second portion 3b is located proximately to the outlet 5 of the first module 1.

According to some embodiments, each wall of the first portion 3a may have a width from 0.1 to 5 mm, and preferably from 0.5 to 1.5 mm. For example, each wall may have a width from 0.1 to 0.5 mm; or from 0.5 to 1 mm; or from 1 to 1.5 mm; or from 1.5 to 2 mm; or from 2 to 2.5 mm; or from 2.5 to 3 mm; or from 3 to 3.5 mm; or from 3.5 to 4 mm; or from 4 to 4.5 mm; or from 4.5 to 5 mm.

The first portion 3a may have a length in the longitudinal direction from 10 to 50 mm, and preferably from 20 to 40 mm. For example, the first portion 3a may have a length in the longitudinal direction from 10 to 15 mm; or from 15 to 20 mm; or from 20 to 25 mm; or from 25 to 30 mm; or from 30 to 35 mm; or from 35 to 40 mm; or from 40 to 45 mm; or from 45 to 50 mm.

According to some embodiments, each wall of the second portion 3b may have a width from 0.05 to 1 mm, and preferably from 0.1 to 0.5 mm. For example, each wall may have a width from 0.05 to 0.1 mm; or from 0.1 to 0.2 mm; or from 0.2 to 0.3 mm; or from 0.3 to 0.4 mm; or from 0.4 to 0.5 mm; or from 0.5 to 0.6 mm; or from 0.6 to 0.7 mm; or from 0.7 to 0.8 mm; or from 0.8 to 0.9 mm; or from 0.9 to 1 mm.

The second portion 3b may have a length in the longitudinal direction from 1 to 10 mm, and preferably from 2 to 8 mm. For example, the second portion 3b may have a length in the longitudinal direction from 1 to 2 mm; or from 2 to 3 mm; or from 3 to 4 mm; or from 4 to 5 mm; or from 5 to 6 mm; or from 6 to 7 mm; or from 7 to 8 mm; or from 8 to 9 mm; or from 9 to 10 mm.

The device further comprises a first capillary (not shown in FIGS. 9 to 12), as described above, which can be inserted into, and therefore can extend in the first channel 3.

According to some preferred embodiments, the width of each wall of the second portion 3b of the first channel 3 is equal to or less than five times the outer diameter of the first capillary at its outlet (in other words, at its most tapered end from where the droplets are formed).

Therefore, the first capillary may be inserted into the first channel 3 through the inlet 4 (and through the circular cross-sectional portion 4a). The non-tapered end (inlet) of the first capillary may be located proximately to the inlet 4 and in the first portion 3a of the first channel 3. The second portion 3b of the first channel 3 thus makes it possible to prevent the first capillary (due to the presence of its non-tapered portion) from further advancing in the channel 3.

The tapered end (outlet) of the first capillary may be located proximately to the outlet 5, and in the second (and smaller) portion 3b of the first channel 3.

Alternatively, in some embodiments (and as further exemplified below), a further capillary may be placed within at least part of the first channel 3, for example in the circular cross-sectional portion 5a. The outlet of the first capillary may be positioned in this further capillary, in which case said further capillary is considered for the purpose of the present description as being part of the first channel 3 itself. This makes it possible to provide a constriction within the first channel 3 down to the diameter required for an appropriate generation of droplets.

According to some embodiments, the inlet 4 of the first module 1 is an inlet for a stream of a first fluid. This inlet 4 may be in fluid communication with the first capillary so that when a first fluid is inserted from the inlet 4, it may circulate directly in the first capillary.

The device (and more particularly the first module 1) may further comprise an additional inlet 6 for a stream of a second fluid. In this case, the inlet for the second fluid 6 is in fluid communication with the first channel 3 so that when a second fluid is inserted from the additional inlet 6, it may circulate directly in the first channel 3. The additional inlet 6 may for example be located at an upper surface 7 of the first module 1 (as illustrated in FIGS. 9 and 10), or at a lower surface 8 of the first module, or at one of the two side surfaces 9, 10 of the first module 1 (not illustrated).

According to some preferred embodiments, and as illustrated in FIGS. 9 and 10, the first module 1 may have a uniform thickness. This means that the distance C between the upper surface 7 and the lower surface 8 of the first module 1 is the same (or substantially the same) at every part of the first module 1.

According to other embodiments, not illustrated in the figures, the distance C between the upper surface 7 and the lower surface 8 of the first module 1 is different from one part of the first module 1 to another. In this case, the module 1 does not have a uniform thickness.

Referring to FIGS. 11 and 12, the second module 2 of the device according to the invention comprises a second channel 11 extending longitudinally from an inlet 12 to an outlet 13 of the second module 2.

According to some embodiments (illustrated in FIGS. 11 and 12), the second channel 11 is microfabricated in the second module 2.

The second channel 11 comprises an observation area wherein the movement and trajectory of the droplets may be studied. The observation area can be defined as an area in the second channel 11, wherein the zone of the second module 2 (or of the device) surrounding the observation area is fabricated from a substantially transparent material which allows the observation of the droplets along the observation axis. For example, the observation axis may be oriented from an upper surface of the device or second module to a lower surface of the device or second module (or the other way around), as illustrated on the figures.

The outlet 13 of the second channel 11 may be connected to a tube for evacuating the emulsion from the device. This tube may for example lead to a cell wherein the emulsion is collected for further disposal.

The first module 1 and second module 2 are connected to each other. The connection may be such that the first channel 3 is aligned with the second channel 11. The connection may be obtained via a second capillary (not illustrated in the figures). The second capillary may preferably have a circular cross-sectional shape. Alternatively, the second capillary may have a cross-section that is not circular for example polygonal, or rectangular cross-section notably square cross-section.

More particularly, a first part of the second capillary can be inserted into the circular cross-sectional portion 5a of the first channel 3, while a second part of the second capillary can be inserted into the circular cross-sectional part 12a of the second channel 11. Thus, the second capillary must have an external diameter which is equal to or substantially equal to the diameter of the circular cross-sectional portion 5a and the diameter of the circular cross-sectional portion 12a.

Alternatively, a third channel may be formed by the circular cross-sectional portion 5a belonging to the first channel 3 and the circular cross-sectional portion 12a belonging to the second channel 11.

Alternatively (not shown on the drawings), the second capillary can be fabricated with the first channel 3 and the second channel 11, in other words the second capillary and the first and the second channels 3, 11 are integrally formed as a single piece.

Part of the tapered portion (comprising the outlet) of the first capillary may be located inside the second capillary (this part of the second capillary being found in the first channel 3 and therefore considered as being part of the first channel 3 as detailed above). Therefore, when the droplets are formed at the outlet of the first capillary, they may directly enter the second capillary (and then go to the second channel 11).

Alternatively, the outlet of the first capillary may be located in the first channel 3 and outside of the second capillary. This means that the droplets are formed at the outlet of the first capillary, enter the first channel 3 (wherein the first and the second capillary are located) and then the second channel 11.

The second capillary may have an internal diameter from 0.02 to 0.3 mm, and preferably from 0.05 to 0.1 mm. For example, the second capillary may have an internal diameter from 0.02 to 0.05 mm; or from 0.05 to 0.1 mm; or from 0.1 to 0.15 mm; or from 0.15 to 0.2 mm; or from 0.2 to 0.25 mm; or from 0.25 to 0.3 mm.

Furthermore, the second capillary may have an external diameter from 2.5 to 6 mm. For example, the external diameter of the second capillary may be from 2.5 to 3 mm; or from 3 to 3.5 mm; or from 3.5 to 4 mm; or from 4 to 4.5 mm; or from 4.5 to 5 mm; or from 5 to 5.5 mm; or from 5.5 to 6 mm.

According to some embodiments, the second capillary may have a length from 10 to 50 mm, and preferably from 15 to 25 mm. For example, the second capillary may have a length from 10 to 15 mm; or from 15 to 20 mm; or from 20 to 25 mm; or from 25 to 30 mm; or from 30 to 35 mm; or from 35 to 40 mm; or from 40 to 45 mm; or from 45 to 50 mm.

The electrodes (not shown) may be inserted into grooves 18 formed on one or more than one of the surfaces (upper 14, lower 15, first side 16, second side 17) of the second module 2. For example, the grooves 18 may be located on the upper surface 14 of the second module 2, as illustrated. In this case the observation area extends longitudinally between the grooves 18. In other words, the electrodes may be located longitudinally spaced apart, one electrode being located upstream of the observation area and the other electrode being located downstream of the observation area.

1-65. (canceled)

66. A method for determining the electrophoretic velocity of droplets of a first fluid in a second fluid, the method comprising:
providing a first capillary (3′) having an outlet positioned in a first channel (3);
providing a stream of the first fluid in the first capillary (3′) and providing a stream of the second fluid in the first channel (3) external to the first capillary (3′), so as to generate droplets of the first fluid in the second fluid at the outlet of the first capillary (3′);
transporting the droplets to an observation area in a second channel (11);
applying an electric field to the observation area of the second channel (11); and
measuring the velocity of the droplets in the observation area.

67. The method according to claim 66, wherein the residence time of the droplets between the outlet of the first capillary (3′) and the observation area is from 1 ms to 1 h.

68. The method according to claim 66, wherein the composition of the first fluid and/or the composition of the second fluid are modified by the addition of additional compounds during the implementation of the method.

69. The method according to claim 66, wherein the first fluid is oil, and/or wherein the second fluid is an aqueous solution.

70. The method according to claim 66, wherein the first fluid stream has a flow rate from 0.0001 to 1 μL/min, and/or wherein the second fluid stream has a flow rate from 0.01 to 1000 μL/min.

71. The method according to claim 66, wherein the velocity of the droplets in the observation area is measured by recording images of the observation area and tracking droplets on successive images.

72. The method according to claim 66, wherein the electrophoretic velocity is calculated by subtracting an electroosmotic flow velocity from the difference between the measured velocity of the droplets in the observation area in the presence and in the absence of the electric field.

73. The method according to claim 66, wherein:
the velocity of the droplets is measured in the observation area in pressure-imposed boundary conditions and in flow-imposed boundary conditions;
the electrophoretic velocity is calculated by adding the velocity in the presence of the electric field in pressure-imposed boundary conditions and the velocity in the presence of the electric field in flow-imposed boundary conditions, and dividing by two.

74. A device for determining the electrophoretic velocity of droplets of a first fluid in a second fluid, the device comprising:
a first channel (3);
a first capillary (3′) having an outlet, placed within the first channel (3);
a second channel (11) in fluid communication with the first channel (3), wherein the second channel (11) comprises an observation area; and
electrodes (19) for applying an electric field in the observation area (200).

75. The device according to claim 74, where the first channel (3) and the second channel (11) are:
made by 3D-printing or machined in a single piece; or
made by 3D-printing or machined as an assembly of separate interconnected parts; or
respective capillaries assembled together.

76. The device according to claim 74, wherein, at the outlet of the first capillary (3′), the inner diameter of the first channel (3) is equal to or less than 5 times the outer diameter of the first capillary (3′).

77. The device according to claim 74, wherein the first channel (3) comprises a first portion (3a) and a second constricted portion (3b).

78. The device according to claim 74, wherein the first capillary (3′) is tapered at its outlet.

79. The device according to claim 74, wherein the second channel (11) is connected to the first channel (3) via a second capillary, wherein the second capillary has a first part placed in the first channel (3) and a second part placed in the second channel (11).

80. The device according to claim 74, further comprising an inlet (4) for a first fluid, and wherein the inlet for a first fluid is in communication with the first capillary (3′).

81. The device according to claim 74, further comprising an additional inlet for a second fluid (6), wherein the inlet for a second fluid (6) is in communication with the first channel (3).

82. The device according to claim 74, wherein the second channel (11) has a square cross-sectional shape, and/or wherein the second channel (11) has a square cross-sectional shape formed by four walls, each wall having a width from 0.1 to 5 mm.

83. The device according to claim 74, wherein the first channel (3) and the second channel (11) are capillaries and/or wherein the device comprises a first module (1) and a second module (2), the two modules being connected to each other, the first module (1) comprising the first channel (3), and the second module (2) comprising the second channel (11).

84. The device according to claim 74, wherein the electrodes (19) are located longitudinally spaced apart, one electrode being located upstream of the observation area and the other electrode being located downstream of the observation area.

85. The device according to claim 74, wherein the electrodes (19) have the form of metal-coated glass slides in order to generate an electric field which is substantially parallel to a direction of observation of droplets in the observation area.
